(19) United States
(12) Patent Application Publication
(10) Pub. No.: US 2009/0182647 A1
(43) Pub. Date: Jul. 16, 2009

(54) SYSTEMS AND METHODS FOR ENHANCING PRODUCT VALUE METADATA

(75) Inventor: Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/346,723

(22) Filed: Dec. 30, 2008

Related U.S. Application Data
(60) Provisional application No. 61/021,692, filed on Jan. 17, 2008.
(60) Provisional application No. 61/021,243, filed on Jan. 15, 2008.

(51) Int. Cl. G06Q 30/00

(52) U.S. Cl. 705/27; 705/26

(57) ABSTRACT

Various embodiments of computer-implemented systems and methods for enhancing product value metadata in an electronic marketplace listing environment are described. One exemplary embodiment includes receiving input from a user, the input being descriptive of a product listed in the marketplace, and determining reputation of the user based on feedback provided by a user community associated with the marketplace. Based on the reputation of the user, a weight is assigned to the input to produce a first weighted input. The first weighted input is aggregated with a second weighted input from a plurality of users to produce an aggregated weighted input. Metadata for the product are then produced based on the aggregated weighted input.

### CROSS-REFERENCE TO RELATED APPLICATIONS

This applications claims priority benefit of U.S. Provisional Application Ser. No. 61/021,692, entitled “ENHANCING PRODUCT VALUE METADATA” filed Jan. 17, 2008 and U.S. Provisional Application Ser. No. 61/021,243, entitled “ENHANCED PRODUCT VALUE METADATA” filed Jan. 15, 2008, which are hereby incorporated by reference in their entirety.

### TECHNICAL FIELD

This application relates generally to data processing, and more specifically to systems and methods of enhancing product value metadata.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all rights whatsoever available in copyright. The following notice applies to the software and data as described below and in the drawings that form a part of this document: Copyright 2008, EBAY, INC., All Rights Reserved.

### BACKGROUND

An electronic marketplace may feature a variety of items listed for sale. Because some of the items listed for sale are unique or old, cataloguing the items based on their product identifications may be difficult or impractical.

### BRIEF DESCRIPTION OF DRAWINGS

Embodiments are illustrated by way of example and not limitation in the Figures of the accompanying drawings, in which like references indicate similar elements and in which:

FIG. 1 is a block diagram showing an exemplary system architecture within which systems and methods for enhancing product value metadata are implemented, in accordance with an exemplary embodiment;

FIG. 2 is a block diagram of a processor using expertise and reputation feedback data to enhance product value metadata, in accordance with an exemplary embodiment;

FIG. 3 is a flow chart of a method of using expertise and reputation feedback data to enhance product value metadata, in accordance with an exemplary embodiment; and

FIG. 4 is a diagrammatic representation of an exemplary machine in the form of a computer system within which a set of instructions for causing the machine to perform any one or more of the methodologies discussed herein is executed.

### DETAILED DESCRIPTION

Machine learning may be utilized in creating a product catalogue for a marketplace based on product metadata. The product metadata may be obtained from user input. The product metadata may also be utilized in helping a user to navigate the marketplace. However, the product metadata obtained from user input may be inaccurate due to user bias, spamming, or lack of knowledge.

The following detailed description includes references to the accompanying drawings, which form a part of the detailed description. The drawings show illustrations in accordance with exemplary embodiments. These exemplary embodiments that are also referred to herein as “examples,” are described in enough detail to enable those skilled in the art to practice the present subject matter. The embodiments may be combined, other embodiments may be utilized, or structural, logical, and electrical changes may be made without departing from a scope of what is claimed. The following detailed description is, therefore, not to be taken in a limiting sense, and the scope is defined by the appended claims and their equivalents.

The description that follows includes illustrative systems, methods, techniques, instruction sequences, and computing machine program products that embody the present invention. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

In this document, the terms “a” or “an” are used, as is common in patent documents, to include one or more than one. In this document, the term “or” is used to refer to a nonexclusive “or,” such that “A or B” includes “A but not B.” “B but not A,” and “A and B,” unless otherwise indicated. Similarly, the term “exemplary” may be construed merely to mean an example of something or an exemplar and not necessarily a preferred means of accomplishing a goal.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

A user (e.g., a seller) within a marketplace may be permitted to specify a variety of attributes and attribute values for an item the user lists on the marketplace (e.g., material, condition, and size). Each of the attributes may be assigned a corresponding attribute value. Example attribute and attribute value pairs may include material=“polyester,” condition=“used,” and size=“medium.” However, the user may be inclined to select only the attributes favorable to the item the user listed for sale in order to market the item more efficiently.

Similarly, attributes the user deems to be unfavorable to the item listed for sale, may be rejected. For example, the user may reject the attribute “condition” in order to avoid specifying of the condition of the item. Thus, because the user may be interested in concealing an attribute, the fact that the item is in a poor condition may remain unknown.

Moreover, the marketplace may permit a user in an “expert” role to provide input with respect to an item listed on the marketplace. The input may be provided by selecting attributes and assigning attribute values to the attributes. However, neutrality and level of expertise of the user in the expert role may be questionable because the user may follow a hidden agenda or simply lack the requisite expertise. Accordingly, whether products are categorized based on the input provided by the listing party or based on the input provided by biased and inexperienced experts, the quality of the categories ultimately selected may be poor.

The systems and methods described herein permit more reliable categorization of products by assessing trustworthiness of the reporting party based on feedback provided by the user community. The trustworthiness of the reporting party may be based on reputation or expertise. Thus, if it is determined that the reporting party has a poor reputation for quality of description, the attributes and values specified by the reporting party may be assigned lesser weight when the attributes and values are considered for categorization of the product.

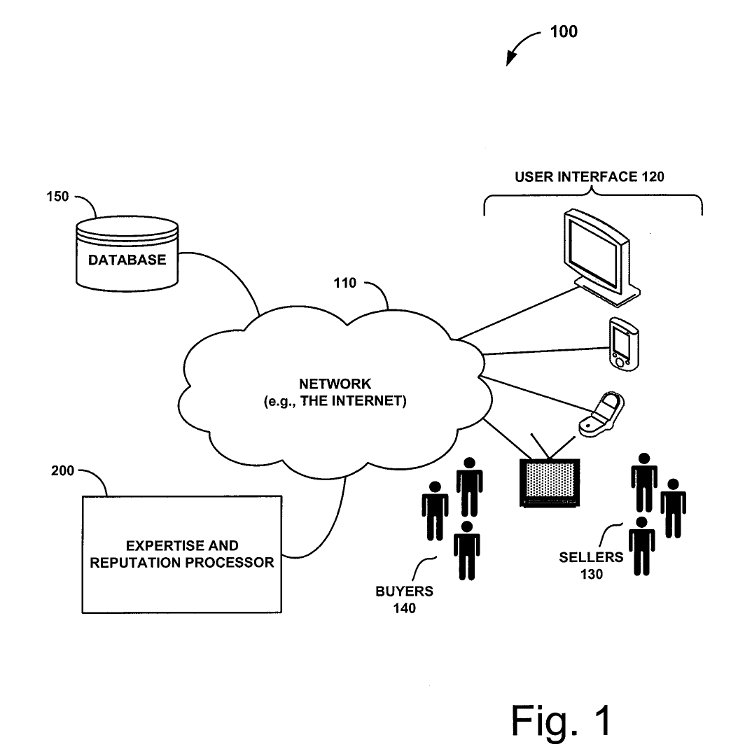

FIG. 1 is a block diagram showing an exemplary system architecture 100 within which systems and methods for enhancing product value metadata may be implemented, in accordance with an exemplary embodiment. As shown in FIG. 1, the exemplary system architecture 100 includes a network 110, one or more user interfaces 120, a plurality of sellers 130, a plurality of buyers 140, an expertise and reputation processor 200, and a database 150. The network 110 can include a network of data processing nodes arranged to be interconnected in various manners for the purpose of data communication. The network 110, in this exemplary embodiment, is arranged to interconnect certain ones of the one or more user interfaces 120, the plurality of sellers 130, the plurality of buyers 140, the expertise and reputation processor 200, and the database 150. The network 110 can also include other connected systems, such as a peer-to-peer or client-server system.

The one or more user interfaces 120, shown in the context of the exemplary system architecture 100, may be configured to allow users to interact with the database 150 via the network 110. The one or more user interfaces 120 may be configured to allow the plurality of sellers 130 to list their items for sale and the plurality of buyers 140 to buy the items listed for sale by the plurality of sellers 130. Transactions engaged in by the plurality of buyers 140 and the plurality of sellers 130 may be processed by the expertise and reputation processor 200.

In the context of the exemplary system architecture 100, machine learning may be combined with the input provided by the marketplace user community to generate metadata for products being listed on the marketplace. The metadata may be used in creating enhanced recommendations of individual products, product features, product categories, and product catalogues. However, quality of the input may be unreliable due to bias, diversity in human perceptions, inexperience, or a hidden agenda of some users. Accordingly, the metadata created based on the input provided by the user community may not accurately describe the product.

To improve the quality of the metadata, the expertise and reputation processor 200 may be utilized to assign weight to the user input. In some exemplary embodiments, the expertise and reputation processor 200 may be configured to process ratings of user expertise or reputation. The expertise and reputation processor 200 may further be utilized to apply an appropriate weight to the input submitted by the users based on the feedback provided by the user community in response to the input submitted by the users in the past. Thus, the ratings of expertise and reputation may be obtained by analyzing the feedback provided by the user community.

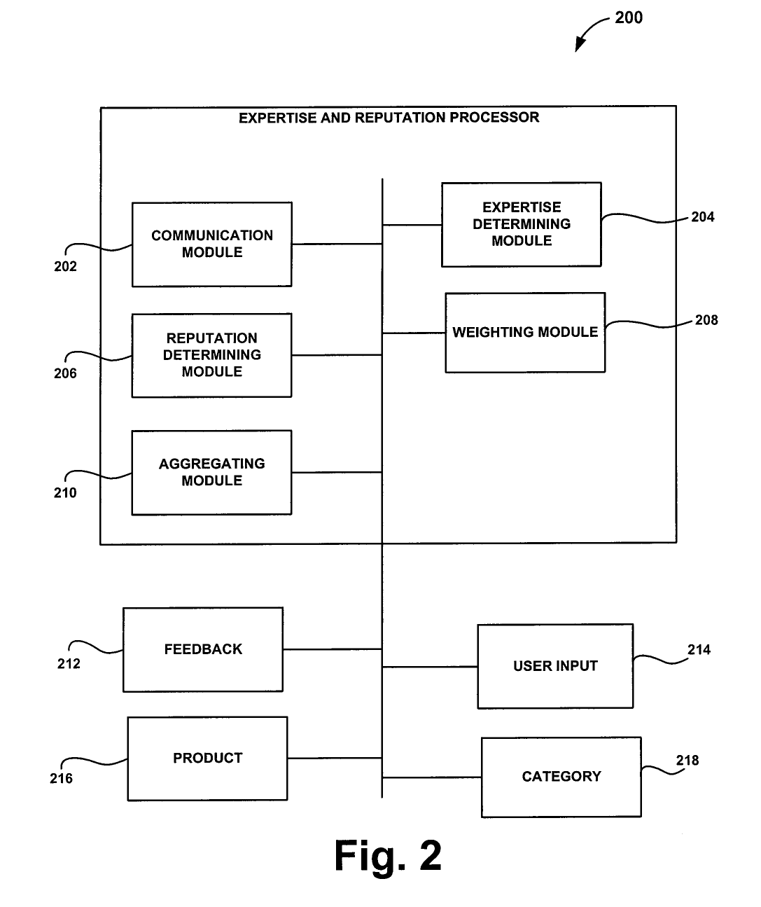

Machines creating enhanced recommendations of individual products, product features, product categories, and product catalogues based on user input may apply a weight the expertise and reputation of the users providing the input. This approach may significantly boost the accuracy of the metadata because it accounts for knowledge and reputations of the users providing input. It will be noted that other criteria of determining expertise and reputation of the users providing input may be utilized. The expertise and reputation processor 200 is described in greater detail below with reference to FIG. 2.

The one or more user interfaces 120 may include a Graphical User Interface (GUI, not shown but known independently in the art). The GUI, instead of offering only text menus or requiring typed commands, graphical icons, visual indicators, or other graphical elements may be configured to allow users to interact with the expertise and reputation processor 200. The one or more user interfaces 120 may be configured to utilize icons used in conjunction with text, labels, or text navigation to more fully represent the information and actions available to users.

The database 150, in some exemplary embodiments, is a structured collection of records or data that are stored in a computer system. A computer program or person using a query language may consult the database 150 to answer queries. The records retrieved in response to queries are information that can be used to make decisions. The database 150 may include user login and profile information. The database 150 may be configured to store information received from the plurality of sellers 130 and the plurality of buyers 140, as well as data generated by the expertise and reputation processor 200. An exemplary system for using user expertise and reputation to enhance product value metadata is described with reference to FIG. 2, below.

FIG. 2 is a block diagram of the expertise and reputation processor 200, in accordance with an exemplary embodiment. The expertise and reputation processor 200 includes a communication module 202, an expertise determining module 204, a reputation determining module 206, a weighting module 208, and an aggregating module 210. Further modules include a feedback module 212, a user input module 214, a product module 216, and a category module 218.

The communication module 202 may be configured to receive input from the user input module 214 and the feedback module 212 from the plurality of sellers 130, the plurality of buyers 140, and other members of the user community including the users in the expert roles. The communication module 202 may further transmit other information via the network 110 of FIG. 1. The expertise determining module 204 and the reputation determining module 206 may be configured to determine a weight assigned to inputs in the user input module 214 when product metadata is generated. The weight is determined based on responses in the feedback module 212 provided by the user community. As mentioned above, while directly using user input from the user input module 214 from the user community may utilized to create product metadata, the metadata may be inaccurate. If only the user input is aggregated to create product descriptions, the product descriptions can become biased.

The expertise determining module 204 and the reputation determining module 206 can facilitate differentiating between users based upon their expertise and reputation. Expertise may be derived from, for example, the frequency with which users sell or buy in the category of the product. Information provided by the plurality of sellers 130 may be utilized by the expertise determining module 204 and the reputation determining module 206 to determine how to weigh users' behaviors when the users accept or reject a recommendation with respect to offered attributes.

The information provided by the plurality of buyers 140 may be utilized to determine how to weigh their behavior based upon how they search, navigate, or browse. Reputation may be derived from user feedback with respect to other users in the appropriate categories. However, global feedback may also be used. The plurality of sellers 130 and the plurality of buyers 140 with higher expertise and reputation as determined by the expertise determining module 204 and the reputation determining module 206 can be weighted higher than those with lower or inadequate expertise and reputation ratings. Keeping track of the diversity in expertise and reputation may result in faster and better convergence and adaptability to changing data.

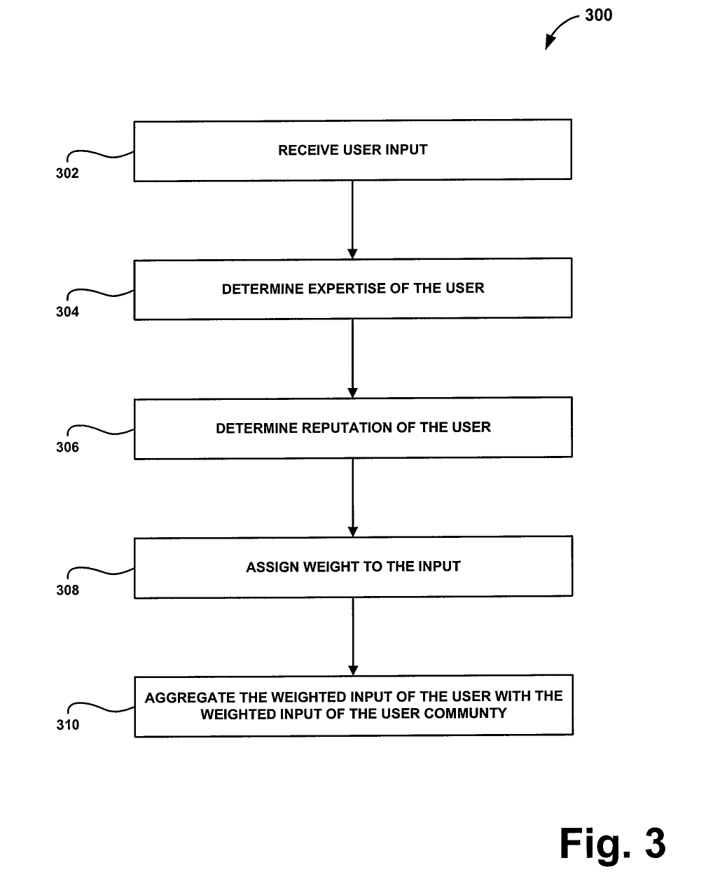

The weighting module 208 may be configured to determine what weight is assigned to information in the user input module 214 based on analysis performed by the expertise determining module 204 and the reputation determining module 206. The user input module 214 includes, in some exemplary embodiments, one or more attributes and corresponding attribute values selected by the user community. The aggregating module 210 may be configured to aggregate the user input module 214 in order to create metadata for the product module 216. The metadata may then be used to place the product module 216 in the category module 218. An exemplary method for using user expertise and reputation to enhance product value metadata is described with reference to FIG. 3, below.

As mentioned above, an item listed on a marketplace may not be catalogued because the item is lacking any product identification. For example, a brand-new voice recorder may be attributed a product identification based on the manufacturer's model number, but a voice recorder that is nearly 100 years old may have no model number associated with it. Moreover, even if the older voice recorder is attributed a product identification it cannot easily be categorized due to a possible sentimental value of the product. Thus, if an item formerly belonged to a famous person, a categorization based solely on the product identification does not represent the value of the item correctly. Furthermore, in some cases it may be difficult to attribute an identification to an item because the item is handmade. Thus, a categorization based on the attributes entered by the user community may be more informative than the one based solely on the product ID.

The user community may provide input to the user input module 214 via a variety of methods. For example, a user listing a car for sale may specify that the car for sale has a dent in the front, and was purchased for the user's daughter. Input obtained from a listing of one item may be insufficient to create a description of the corresponding product. Instead, user input provided by a plurality of users is aggregated by the aggregating module 210 to create product metadata. Based on the product metadata obtained from the input created by many users in the user community, the category to which the product belongs may be determined.

With reference concurrently to FIGS. 2 and 3, a flow chart of a method 300 of using expertise and reputation to enhance product value metadata, in accordance with an exemplary embodiment. The method 300 may be performed by processing logic that comprises hardware (e.g., dedicated logic, programmable logic, microcode, etc.), software (such as run on a general-purpose computer system or a dedicated machine), or a combination of both. In an exemplary embodiment, the processing logic resides within the expertise and reputation processor 200 illustrated in FIGS. 1 and 2. The method 300 may be performed by one or more of the various modules discussed above with reference to FIG. 2. Each of these modules may comprise processing logic.

The flow of the method 300 commences at operation 302 with the communication module 202 of the expertise and reputation processor 200 receiving user input. At operation 304, the expertise determining module 204 of the expertise and reputation processor 200 determines the expertise of the user by querying the database 150 for data related to the user transaction history. At operation 306, the expertise determining module 204 and the reputation determining module 206 of the expertise and reputation processor 200 determines the expertise and reputation of the user based on the user transaction history.

At operation 308, the weighting module 208 of the expertise and reputation processor 200 assigns weights to the input created by the user based on the user expertise and reputation as determined by the expertise determining module 204 and the reputation determining module 206. At operation 310, the aggregating module 210 of the expertise and reputation processor 200 aggregates the weighted input. The aggregation of the weighted inputs may be performed by a linear or nonlinear summation of the inputs selected by the plurality of sellers 130 from the recommended attributes and values, wherein each input is assigned a coefficient based on the expertise and reputation of the corresponding seller.

The expertise and reputation processor 200 may utilize the aggregated input created by the user community. The aggregated input may be created when the plurality of sellers 130 specify what they are listing by selecting or rejecting product attributes suggested by the expertise and reputation processor 200. For example, a seller may specify that he is listing a certain kind of archery implement, such as a bow and arrow set. The expertise and reputation processor 200 may not know what the attribute values are, but the seller may have expertise in bow and arrow sets and related items.

In addition to selecting existing attributes, the plurality of sellers 130 may create new attributes when listing items. The new attributes created by the plurality of sellers 130 may later be suggested to other sellers of similar items. For example, when a seller enters the title of the item (e.g. a used polyester shirt), the seller may be provided with several suggested attributes and corresponding values (e.g. material=“polyester,” condition=“used,” size=“medium”). In some exemplary embodiments, the expertise and reputation processor 200 may create suggested attributes by analyzing the title and the words in the title. Other descriptive information with respect to a particular item may also be analyzed. Additionally, other criteria may be used in creation and suggestions of attributes and the corresponding attribute values. For example, a system may be established in which product managers write business rules to interpret user input. As an example, if a user enters “blue dress, Calvin Klein, medium size,” the attributes and the corresponding attribute values suggested to the user may include “color=blue, tag=dress, size=six, brand=Calvin Klein.”

As mentioned above, the plurality of sellers 130 may have an option of accepting or rejecting the suggested attributes. However, the seller may be biased and reject the attributes that describe the item unfavorably and accept the attributes that describe the item favorably. The method 300 of using user expertise and reputation to enhance product value metadata may improve quality of attributes created by the user community by accounting for expertise and reputation of the users. In some exemplary embodiments, the reputation may be based on feedback in the feedback module 212 received by the user. The feedback module 212 related to transactions in certain product categories may be more relevant than the global feedback (obtained from a variety of unrelated categories). However, when sufficient product category feedback is not available, the global feedback may be useful in determining how much weight to assign to the user input.

For example, a user who typically sells shirts list a plasma TV for sale. The user may never have listed or purchased a plasma TV and is not otherwise active in the electronics category. When the user accepts or rejects an attribute that is recommended by the expertise and reputation processor 200 for a plasma TV, or for other items in the electronics category, actions by the user may be given lesser weight or even negative weight when creating user community metadata for the item. Alternatively, even though the user has never listed a plasma TV for sale, the system may assign more weight to the user actions if the user has a good reputation in other categories. For example, the user may be a reliable seller of shirts in the shirt category and has no incentive to diminish his reputation by providing incorrect information in the electronics category.

In some exemplary embodiments, a system for using user expertise and reputation to enhance product value metadata may be implemented as a learning system. For example, a seller having a reputation for reliable input in some other category may enter “shirt, medium size, Calvin Klein.” In response, the expertise and reputation processor 200 may recommend “size=16.” The user, knowing that the Calvin Klein brand does not have a medium size shirt that translates into size 16, may reject the suggestion. Because the user is a well-reputed seller, the system may assign a higher weight to the rejection than to an acceptance or rejection made by a seller with lower reputation ratings.

In some exemplary embodiments, a system for using user expertise and reputation to enhance product value metadata may include a hidden test to determine user reliability by suggesting an attribute value conflicting with values selected by reputed users. In some exemplary embodiments, the reputation is established by determining whether a user provides feedback in his typical historical transaction price range. For example, a user who typically conducts transactions that involve $5 items may provide feedback for a $15,000 item. Such feedback may be given little weight because the user has no reputation in transactions involving higher priced items.

In some exemplary embodiments, users may be allowed to modify, completely change, or introduce a new attribute. For example, a seller may want to enter his own name as the value of the “seller” attribute. If this attribute results in little activity of reputed buyers with respect to the listing, the system may determine that there was an attempt to scam the system. In another example situation, a buyer may set up a new account in order to provide feedback for his own transactions associated with a different account in an attempt to increase his reputation. The system may determine that the user providing the feedback has no transaction history and exclude the feedback when assigning a weight to the user input. Alternatively, the weight may be decreased due to an attempt to deceive the system.

Similarly, weights assigned to attributes may be utilized in the navigation of a marketplace or creating a catalogue. For example, a catalogue for shirts may include a spreadsheet or table including a manufacturer, a size, a color, and a material. In order to create a high quality catalogue, the attributes of the catalogue products should be accurate. Weights assigned to the attributes may provide a navigation mechanism in the marketplace. This approach may also be helpful in providing correct categories in response to user searches. The method 300 for using user expertise and reputation to enhance product value metadata may also lessen the likelihood that the plurality of sellers 130 can promote their products by assigning biased values to the properties of the descriptions.

In some exemplary embodiments, the system may also be operable to rate user reputation by determining the differences between the values selected by a specific user and the values selected by other reputable users. The system may assign weighting coefficients to selections made by users based on the differences between the values. In some exemplary embodiments, the system may be primed by having experts assign default attributes and several possible attribute values. Once the primed system is open to sellers, it may become self-correcting. Thus, a system for using user expertise and reputation to enhance product value metadata can be a self-correcting system, which is useful in a marketplace environment because of a large volume of data and a wide variety of products.

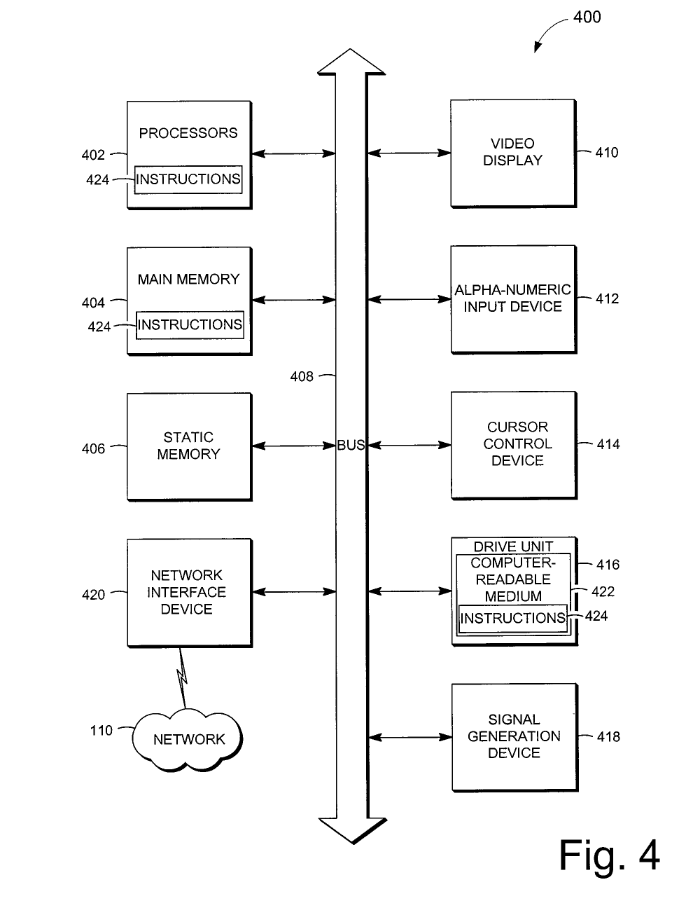

FIG. 4 is a diagrammatic representation of an exemplary machine in the form of a computer system 400 within which a set of instructions 424 for causing the machine to perform any one or more of the methodologies discussed herein is executed. In various exemplary embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may comprise a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes one or more processors 402 (e.g., a central processing unit (CPU), a graphics processing unit (GPU), or both), and a main memory 404 and a static memory 406, which communicate with each other via a bus 408. The computer system 400 may further include a video display unit 410 (e.g., a liquid crystal display (LCD) or a cathode ray tube (CRT)). The computer system 400 may also include an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a computer-readable medium 422 on which is stored one or more sets of instructions and data structures (e.g., the set of instructions 424) embodying or utilized by any one or more of the methodologies or functions described herein. The set of instructions 424 may also reside, completely or at least partially, within the main memory 404, or within the one or more processors 402 during execution thereof by the computer system 400. The main memory 404 and the one or more processors 402 may also constitute machine-readable media.

The set of instructions 424 may further be transmitted or received over the network 110 via the network interface device 420 utilizing any one of a number of well-known transfer protocols (e.g., Hyper Text Transfer Protocol (HTTP)).

While the computer-readable medium 422 is shown in an exemplary embodiment to be a single medium, the term “computer-readable medium” should be taken to include a single medium or multiple media (e.g., a centralized or distributed database or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The exemplary embodiments described herein may be implemented in an operating environment comprising software installed on a computer, in hardware, or in a combination of software and hardware.

Thus, methods and systems using expertise and reputation to enhance product value metadata have been described. Although embodiments have been described with reference to specific exemplary embodiments, it will be evident that various modifications and changes may be made to these embodiments without departing from the scope of the technology described herein. Accordingly, the specification and drawings are to be regarded in an illustrative rather than a restrictive sense.

What is claimed is:

1. A method to enhance product value metadata in an electronic marketplace, the method comprising:
using one or more processors to perform at least a portion of one or more of the following acts:
receiving input from a user, the input being descriptive of a product listed on a marketplace;
determining a reputation of the user based on feedback provided by a user community associated with the marketplace;
based on the reputation of the user, assigning a weight to the input to produce a first weighted input;
aggregating the first weighted input with a second weighted input from a plurality of users to produce an aggregated weighted input; and
creating metadata for the product based on the aggregated weighted input.

2. The method of claim 1, further comprising creating a product catalogue based on the metadata.

3. The method of claim 1, further comprising utilizing the metadata in navigation of the marketplace.

4. The method of claim 1, further comprising determining a category in which the product belongs based on the metadata.

5. The method of claim 1, wherein the aggregating of the first weighted input with the second weighted input is performed by assigning and applying a first and a second coefficient to the first and second weighted inputs, respectively, and summing the first and the second weighted inputs with the respective coefficients applied.

6. A computer-implemented system, the system comprising:
a receiving module to receive input from a user, the input being descriptive of a product listed on a marketplace; and
an expertise and reputation processor to:
determine a reputation of the user based on feedback provided by a user community associated with the marketplace,
assign a weight to the input to produce a first weighted input based on the reputation of the user,
aggregate the first weighted input with the second weighted input from a plurality of users to produce an aggregated weighted input, and
create metadata for the product based on the aggregated weighted input.

7. The computer-implemented system of claim 6, further comprising a catalogue module to create a product catalogue based on the metadata.

8. The computer-implemented system of claim 6, further comprising a navigating module to utilize the metadata in navigation of the marketplace.

9. The computer-implemented system of claim 6, further comprising a category building module to determine a category in which the product belongs based on the metadata.

10. The computer-implemented system of claim 6, further comprising an aggregating module to aggregate the first weighted input with the second weighted input from the plurality of users by assigning and applying a first and a second coefficient, respectively, to the first and second weighted inputs and summing the first and the second weighted inputs with the respective coefficients applied.

11. The computer-implemented system of claim 6, wherein the weight is determined based on at least one attribute and a corresponding attribute value for each of the at least one attribute, each selected or rejected by the user.

12. The computer-implemented system of claim 6, wherein the input includes at least one attribute and a corresponding attribute value for each of the at least one attribute, each created by the user.

13. The computer-implemented system of claim 6, wherein the feedback relates to a transaction history of the user.

14. The computer-implemented system of claim 6, wherein the receiving module is further to receive input for the product listed on the marketplace.

15. The computer-implemented system of claim 6, wherein the expertise and reputation processor is further to utilize the metadata in creating an enhanced recommendation for one or more of the following: a product, a product feature, a product category, and a product catalogue.

16. The computer-implemented system of claim 6, wherein the expertise and reputation processor is further to determine the reputation of the user based on a frequency with which the user transacts in a category of the product.

17. The computer-implemented system of claim 6, wherein the reputation of the user is based on user feedback with respect to other users.

18. The computer-implemented system of claim 6, wherein the reputation of the user is based on a reputation of users providing the feedback to the user.

19. The computer-implemented system of claim 6, wherein the reputation of the user is based on feedback in a defined category.

20. The computer-implemented system of claim 6, wherein the reputation of the user is based on feedback in a plurality of categories.

21. The computer-implemented system of claim 6, wherein the input is based on at least one attribute and a corresponding attribute value for each of the at least one attribute, each created by the user, the at least one attribute and the corresponding attribute value being created based on analyzing words in a description of the product.

22. The computer-implemented system of claim 6, wherein the reputation is further based on an attribute selected by the user, the attribute being provided to test user reliability.

23. The computer-implemented system of claim 6, wherein the reputation is further based on feedback provided in a historical transaction price range.

24. A machine-readable storage medium comprising instructions, which when executed by one or more processors, perform a method to enhance product value metadata in an electronic marketplace, the method comprising:
receiving input from a user, the input being descriptive of a product listed in the electronic marketplace;
determining a reputation of the user based on feedback provided by a user community associated with the marketplace;
based on the reputation of the user, assigning a weight to the input to produce a first weighted input;
aggregating the first weighted input with a second weighted input from a plurality of users to produce an aggregated weighted input; and
creating metadata for the product based on the aggregated weighted input.

25. The machine-readable storage medium of claim 24, wherein the aggregating of the first weighted input with the second weighted input from the plurality of users includes assigning and applying a first and a second coefficient, respectively, to the first and second weighted inputs and summing the first and the second weighted inputs with the respective coefficients applied.

26. The machine-readable storage medium of claim 24, wherein the weight is determined based on at least one attribute and a corresponding attribute value for each of the at least one attribute, each selected or rejected by the user.

27. The machine-readable storage medium of claim 24, wherein the input includes at least one attribute and a corresponding attribute value for each of the at least one attribute, each created by the user.

28. The machine-readable storage medium of claim 24, wherein the feedback relates to a transaction history of the user.

29. An apparatus for enhancing product value metadata in an electronic marketplace, the apparatus comprising:
means for receiving input from a user, the input being descriptive of a product listed in the marketplace;
means for determining a reputation of the user based on feedback provided by a user community associated with the marketplace;
means for assigning a weight to the input to produce a first weighted input based on the reputation of the user;
means for aggregating the first weighted input with a second weighted input from a plurality of users to produce an aggregated weighted input; and
means for creating metadata for the product based on the aggregated weighted input.

30. The apparatus of claim 29, wherein the weight is determined based on at least one attribute and a corresponding attribute value for each of the at least one attribute, each selected or rejected by the user.
